(19) United States
(12) Patent Application Publication
(10) Pub. No.: US 2009/0205926 A1
(43) Pub. Date: Aug. 20, 2009

(54) MEDIA RECOGNITION DEVICE AND METHOD

(75) Inventors: James S. Piccirillo, Middletown, CT (US); Eugene Domnich, West Hartford, CT (US); Wayne J. Hooper, Clinton, CT (US); Christopher E. Lamourine, Columbia, CT (US)

Correspondence Address: CANTOR COLBURN, LLP, 20 Church Street, 22nd Floor, Hartford, CT, 06103, US

(73) Assignee: GREENWALD INDUSTRIES, INCORPORATED, Chester, CT (US)

(21) Appl. No.: 12/031,301

(22) Filed: Feb. 14, 2008

(51) Int. Cl. G07D 7/00; G07D 5/00

(52) U.S. Cl. 194/302

(57) ABSTRACT

Disclosed herein is a media recognition device. The device includes, an alley defined by a floor and a wall that is receptive of media passable therethrough, a movable member movable in response to contact with media as the media passes through the alley, a sensor in operable communication with the movable member configured to output a signal proportional to a position of the movable member, and a processor in operable communication with the sensor. The processor is configured to map the output signal of the sensor as the media passes through the alley, the processor is further configured to recognize or distinguish the map of the media from stored maps of known media.

### BACKGROUND OF THE INVENTION

Media recognition devices have commonly been used to identify and/or differentiate between various media such as, coins, chips and tokens, for example. In the past, media recognition systems employed mechanical and simple electronic methods to accept or reject media and differentiate between denominations of media. The mechanical and simple electronic methods that have been employed often lead to improper acceptance of, for example, foreign coins, false media, unwanted media denominations and metal objects that look like proper media. For at least these reasons the industry would be receptive to improvements in the art of media recognition.

### BRIEF DESCRIPTION OF THE INVENTION

Disclosed herein is a media recognition device. The device includes, an alley defined by a floor and a wall that is receptive of media passable therethrough, a movable member movable in response to contact with media as the media passes through the alley, a sensor in operable communication with the movable member configured to output a signal proportional to a position of the movable member, and a processor in operable communication with the sensor. The processor is configured to map the output signal of the sensor as the media passes through the alley, the processor is further configured to recognize or distinguish the map of the media from stored maps of known media.

Further disclosed herein is a method of recognizing media. The method includes, passing media through an alley, moving a movable member via contact with the media as the media passes through the alley, mapping motion of the movable member as the media passes through the alley, and recognizing or distinguishing the map from stored maps of other media.

### BRIEF DESCRIPTION OF THE DRAWINGS

The following descriptions should not be considered limiting in any way. With reference to the accompanying drawings, like elements are numbered alike:

FIG. 1 depicts a perspective view of an embodiment of the media recognition device disclosed herein;

FIG. 2 depicts a side view of the media recognition device of FIG. 1 with a cover removed; and

FIG. 3 depicts a partial cross sectional view of the media recognition device of FIG. 2 taken at arrows 3-3.

### DETAILED DESCRIPTION OF THE INVENTION

A detailed description of one or more embodiments of the disclosed apparatus and method are presented herein by way of exemplification and not limitation with reference to the Figures.

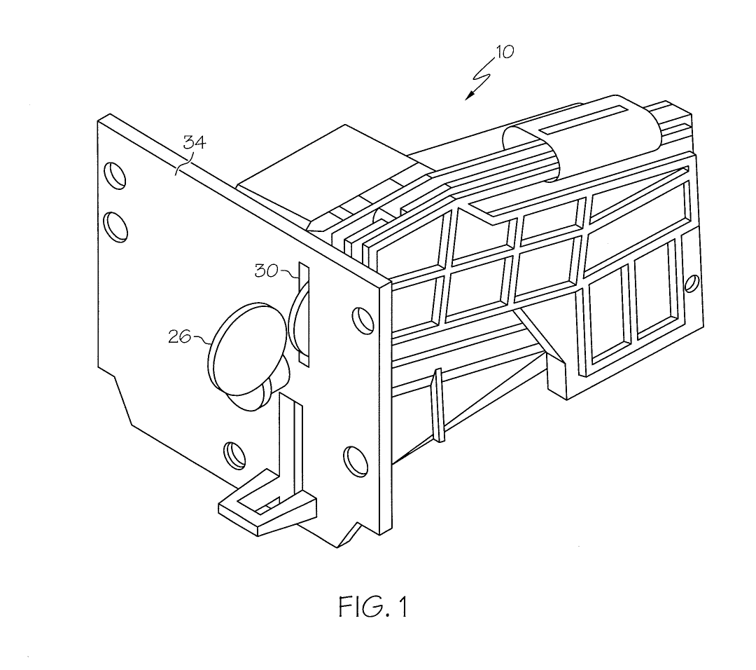

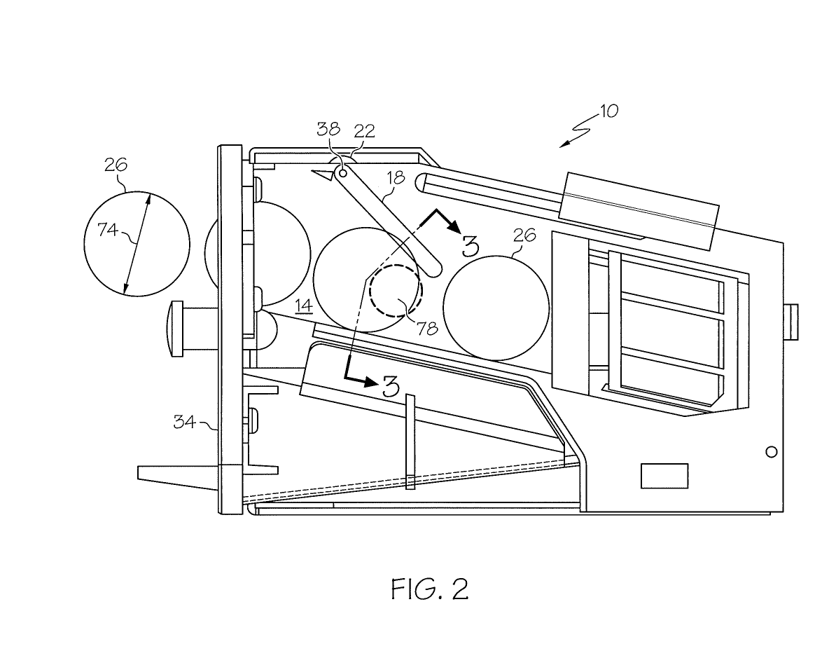

Referring to FIGS. 1 and 2, an embodiment of the media recognition device 10 disclosed herein is illustrated. The media recognition device 10 includes, an alley 14, a movable member 18, a sensor 22 in operable communication with the movable member 18 and a processor (not shown). The media recognition device 10 is receptive of media 26, such as coins, tokens or chips, for example, which are insertable through a slot 30 in a faceplate 34. Once within the device 10 the media 26 is positioned in the alley 14 that, in this embodiment, is sloped at an angle relative to horizontal such that gravitational force, in addition to an initial velocity, causes the media 26 to move or roll downward through the alley 14. Located within the alley 14 is the movable member 18 that, in this embodiment, is pivotal about a pivot axis 38 that is substantially parallel with an axis of the media 26. The movable member 18 and the pivot axis 38 are positioned sufficiently high within the alley 14 to allow the media 26 with the largest expected dimension to pass thereunder. As the media 26 passes through the alley 14, it contacts the movable member 18 causing the movable member 18 to pivot about the pivot axis 38. The movable member 18 first rotates in a counter clockwise direction, as shown in the figures, followed by a clockwise direction of rotation as the media 26 moves thereunder until contact with the movable member 18 is broken. Frictional drag on the media 26 from the movable member 18 should be low to prevent stoppage of the media 26 as it travels through the alley 14. Frictional drag on the media should also be kept low to allow the media 26 to roll as it travels through the alley 14, which, although not necessary for operation of the device 10 disclosed herein, may be desirable for alternate embodiments that include a secondary sensor as will be discussed further below. As such, a counterweight (not shown) may be coupled to the movable member 18 to control this frictional drag. Additionally, the sensor 22 that is in operable communication with the movable member 18 can add to a contact load between the movable member 18 and the media 26. As such, the sensor 22 should be selected and applied in a way to control its contribution to the contact load.

The sensor 22 is coupled to the movable member 18 in such a way that the sensor 22 senses the rotational position of the movable member 18. The sensor 22 may be a quadrature encoder and employ any of several known methods of sensing a position of rotation of an object, such as a change in magnetic properties as with a Hall effect sensor, a change in resistance as with a rheostat sensor, or a change in light magnitude as with an optical sensor, for example. Regardless of the type of sensor 22 used, it is desirable to output a continuously variable, analogue signal to maximize resolution of the position sensed. An analogue signal can be digitized to facilitate processing thereafter. The processor monitors the output of the sensor 22 while the media 26 passes through the alley 14. As such, the processor maps the rotation of the movable member 18 as it first rotates counterclockwise and then clockwise. The map generated for the media 26 is compared with stored maps of known media 26, generated through multiple trips through the device 10, to recognize the media 26. The processor may analyze the maps in analogue form or may convert them to digital files and use digital signal processing algorithms, such as neural networks, for example. To optimize accuracy and repeatability of map recognition the positioning of the media 26, relative to the alley 14 and the movable member 18, as it passes through the alley 14, is very important.

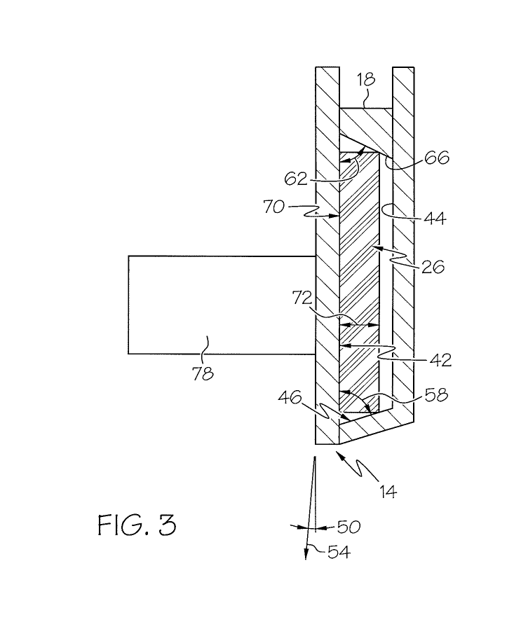

Referring to FIG. 3, a cross sectional view of the alley 14 and the movable member 18 are illustrated with the media 26 positioned therebetween. The alley 14 includes a wall 42, a retaining surface 44 and a floor 46. For accurate sensing, it is preferable that the media 26 remain in contact with both the wall 42 and the floor 46 during passage through the alley 14. The media 26 is biased toward the wall 42 by the force of gravity on the media 26 due to an angle 50 between a plane of the wall 42 and the direction of gravity 54. The media 26 may also be biased toward the wall 42 by an optional acute angle 58 defined by the wall 42 and the floor 46. Further still, the media 26 may be biased toward the wall 42 by another optional acute angle 62 defined by the wall 42 and a guide surface 66 of the movable member 18. With the foregoing biasing, a face 70 of the media 26 should remain in contact with the wall 42 while the movable member 18 is rotationally articulated due to contact with the media 26 passing through the alley 14.

The acute angles 58, 62 are optional since the device 10 is operational without inclusion of the acute angles 58, 62. The acute angles 58, 62, in addition to providing a biasing force to the media 26, have a secondary effect on the map of the media 26 that does not exist in designs having 90-degree angles or obtuse angles, for example. This secondary effect is to have a component of the motion of the movable member 18 be dependent upon a thickness 72 of the media 26. As such, the movement of the movable member 18 is made up of two components, the first and larger component is due to the outer dimension 74, usually a diameter of the media 26, and a second smaller component due to the thickness 72 mentioned above. Having the movement of the movable member 18 made up of two components from the media 26 can improve a performance of the device 10 since two pieces of media 26 with the same diameter, for example, can still be distinguished from one another, by the device 10, due to a difference in their thicknesses 72.

Having the media 26 reliably remain in contact with the wall 42 while passing through the alley 14 can also be beneficial if the device 10 includes a secondary electromagnetic sensor 78, such as an air gapped eddy current detector, for example. These electromagnetic sensors 78 need the media 26 to be a reliable and consistent distance from the electromagnetic sensor 78 as the media 26 passes thereby, in order for readings from the sensor 78 to have a high degree of measurement resolution. Additionally, to achieve such high degrees of measurement resolution these systems may also need the media 26 to rotate as it passes through the alley 14. One way of facilitating rotation of the media 26 is to have the media 26 roll against the floor 46, which may be facilitated, as discussed above, by maintaining a light contact force between the movable member 18 and the media 26.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Furthermore, the use of the terms a, an, etc. do not denote a limitation of quantity, but rather denote the presence of at least one of the referenced item.

What is claimed is:

1. A media recognition device, comprising:
an alley defined by a floor and a wall being receptive of media passable therethuough;
a movable member movable in response to contact with media as the media passes through the alley;
a sensor in operable communication with the movable member configured to output a signal proportional to a position of the movable member; and
a processor in operable communication with the sensor, the processor configured to map the output signal of the sensor as the media passes through the alley, the processor configured to recognize or distinguish the map of the media from stored maps of known media.

2. The media recognition device of claim 1, wherein the wall of the alley is angled relative to the gravitational force of the earth to bias the media against the wall as the media passes through the alley.

3. The media recognition device of claim 1, wherein the floor forms an acute angle with the wall.

4. The media recognition device of claim 1, wherein the movable member is rotatable about an axis that is substantially parallel to an axis of the media.

5. The media recognition device of claim 1, wherein the media recognition device is configured so that the media rolls along the floor.

6. The media recognition device of claim 1, wherein the alley further comprises a retaining surface substantially parallel to the wall forming a channel through which the media is passable.

7. The media recognition device of claim 1, wherein the movable member further comprises a guide surface against which the media makes contact while passing through the alley, the guide surface forming an acute angle with the wall.

8. The media recognition device of claim 1, wherein the sensor is an analogue sensor.

9. The media recognition device of claim 1, wherein the sensor senses at least one of a change in magnetism, resistance and light.

10. The media recognition device of claim 1, further comprising a counterweight in operable communication with the movable member.

11. The media recognition device of claim 1, wherein the processor is configured to use digital signal processing to recognize or distinguish the maps.

12. The media recognition device of claim 1, further comprising a secondary sensor proximate the wall.

13. A method of recognizing media, comprising:
passing media through an alley;
moving a movable member via contact with the media as the media passes through the alley;
mapping motion of the movable member as the media passes through the alley; and
recognizing or distinguishing the map from stored maps of other media.

14. The method of recognizing media of claim 13, wherein the passing the media comprises rolling the media along a floor of the alley.

15. The method of recognizing media of claim 13, wherein the passing the media comprises biasing the media against a wall of the alley.

16. The method of recognizing media of claim 15, wherein the biasing is by at least one of orienting the wall relative to the gravitational force of the earth, forming an acute angle between a floor of the alley and the wall and forming an acute angle between a guide surface of the movable member and the wall.

17. The method of recognizing media of claim 13, further comprising sensing the motion of the movable member as the media passes through the alley.

18. The method of recognizing media of claim 17, wherein the mapping comprises capturing the sensed motion with a processor.

19. The method of recognizing media of claim 13, wherein the recognizing or distinguishing comprises digital signal processing the maps.

20. The method of recognizing media of claim 13, further comprising counterweighing the movable member.
